(19) United States
(12) Patent Application Publication
(10) Pub. No.: US 2006/0043728 A1
(43) Pub. Date: Mar. 2, 2006

(54) Day planner

(76) Inventor: Brad S. Perelman, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/211,144

(22) Filed: Aug. 24, 2005

Related U.S. Application Data
(60) Provisional application No. 60/662,398, filed on Mar. 16, 2005.
(60) Provisional application No. 60/605,095, filed on Aug. 27, 2004.

(51) Int. Cl. B42D 5/04

(52) U.S. Cl. 283/3

(57) ABSTRACT

The present invention is a day planner that visually integrates a solar-based calendar, such as a Gregorian calendar, including a month and daily structure, within a lunar-based calendar, such as a Jewish calendar. More specifically, the present invention allows a user to view his or her daily life via a day planner in relation to Jewish dates. Preferably, the day planner includes at least one Jewish calendar week that incorporates a corresponding Gregorian calendar week per page through visual indicia.

### CROSS REFERENCE TO RELATED APPLICATIONS

This application claims the benefit of U.S. Provisional Application No. 60/662,398, filed Mar. 16, 2005, entitled “Day Planner,” and U.S. Provisional Application No. 60/605,095, filed Aug. 27, 2004, entitled “Day Planner,” which are incorporated herein by reference in their entirety.

### BACKGROUND OF THE INVENTION

1. Field of the Invention

The present invention relates to day planners and, more specifically, to a day planner that corresponds a Jewish calendar to a Gregorian calendar.

2. Description of Related Art

Generally speaking, the calendar of the Western civilization is a Gregorian calendar which is solar-based, having approximately 365.25 calendar days each year. It begins on January 1^{st} and ends on December 31^{st}, with each Gregorian calendar day stretching from midnight to midnight.

The Jewish calendar was inaugurated over three thousand years ago upon G-d's commandment to the Jews in Egypt to proclaim the holiness of the month of Nissan. Since that first commandment and first collective act of Jewish nationhood, the lunar-based calendar, with Rabbinically calculated seasonal adjustments, has guided the Jews throughout history. During the times of the First and Second Temples, the Sanhedrin (i.e., The Great Assembly), certified witnesses of the New Moon, sanctified the New Month (i.e., Rosh Chodesh), and announced it through a system of hilltop fires and messengers. This procedure remained in force until the fourth century C.E., when Hillel II fixed all the future Jewish months and years.

This order of the Hebrew Months continues to be universally accepted in Israel and in the Diaspora.

In addition to the Jewish calendar being lunar-based, with each month beginning on the appearance of a new moon, the Jewish day stretches from sunset to sunset. Thus, a strictly Jewish calendar begins at sunset on the first day of the month of Tishrei, i.e., the Jewish New Year, Rosh Hashanah.

The visual indicia used to indicate days in prior art Jewish calendars represents the secular day stretching from midnight to midnight, as opposed to the Jewish day stretching from sunset to sunset.

What is needed and has not heretofore been developed is a day planner that visually integrates the Gregorian solar-based calendar, including monthly and daily structure, within a Jewish lunar-based calendar with its unique month and day structure. Accordingly, it is an object of the present invention to provide a lunar day planner and Gregorian solar-based day planner that better represents the Jewish calendar.

### SUMMARY OF THE INVENTION

The present invention is a day planner that visually integrates a solar-based calendar, such as a Gregorian calendar, including a monthly and daily structure, within a lunar-based calendar, such as a Jewish calendar. More specifically, the present invention allows a user to view his or her daily life via a day planner in relation to Jewish dates. The day planner has a medium upon which a plurality of indicia is applied and each of the indicia coacts with adjacent indicia and is visually indicative of a complete lunar day and a partial solar day. Each indicia has a first portion and a second portion, the first portion identifying a beginning of the complete lunar day and an ending of a first solar day, the second portion identifying a beginning of a second solar day and an ending of the complete lunar day. Further, the first portion may identify the beginning of a complete solar day and the ending of a first lunar day, and the second portion may identify the beginning of a second lunar day and the ending of a complete solar day. The indicia illustrates the lunar day from a first sunset to a second sunset. The indicia further illustrates the solar day from a first midnight to a second midnight. Further, the indicia form a plurality of indicia that may identify a plurality of days, weeks, months, or one or more years. Preferably, the day planner includes at least one Jewish calendar week that incorporates a corresponding Gregorian calendar week per page through visual indicia.

The first portion of the day planner has a plurality of horizontal lines and the second portion has a plurality of horizontal lines. The first portion may be adjacent to or beside the second portion. Alternatively, the first portion may be positioned above the second portion. Further, the first portion may be shaded in color.

A plurality of sunset indicia to visually indicate the lunar day spanning from the first sunset to second sunset may also be provided. Additionally, a plurality of clock indicia to visually indicate the solar day spanning from the first midnight to the second midnight may be provided. Also, at least one of a candle indicia may be provided to visually indicate candle lighting times according to Jewish custom. Additional indicia, i.e., shading or shapes, could indicate whether a Jewish observance or practice is to be performed only in the day, only in the night, or encompasses both, for a Jewish date, i.e., “Kolnidre” (night) or a fast day (during the day or during the day and night).

The day planner may also have a day range depicted on the medium. The medium may be a print paper and the print paper may be contained in a binder or a desktop planner.

### BRIEF DESCRIPTION OF THE DRAWINGS

FIG. 1 shows a Jewish calendar week according to a first embodiment of the present invention;

FIG. 2 shows a Jewish calendar week according to a second embodiment of the present invention;

FIG. 3 shows a Jewish calendar day block according to an alternative embodiment of the present invention;

FIG. 4 shows two Jewish calendar day blocks according to an alternative embodiment of the present invention;

FIG. 5 is a top plan view of a ring binder day planner according to the present invention; and

FIG. 6 is a top plan view of a desktop day planner according to the present invention.

### DETAILED DESCRIPTION OF THE INVENTION

For purposes of the description hereinafter, the terms “top,” “bottom,” “left,” “right,” “horizontal,” and “vertical,” and derivatives thereof, shall relate to the invention as it is oriented in the drawing figures. However, it is to be understood that the invention may assume various alternative variations, except where expressly specified to the contrary. Further, many desirable features of the invention will be apparent to those of ordinary skill in the art upon reading the description of the invention, taken with the accompanying figures, wherein like reference numerals represent like elements throughout.

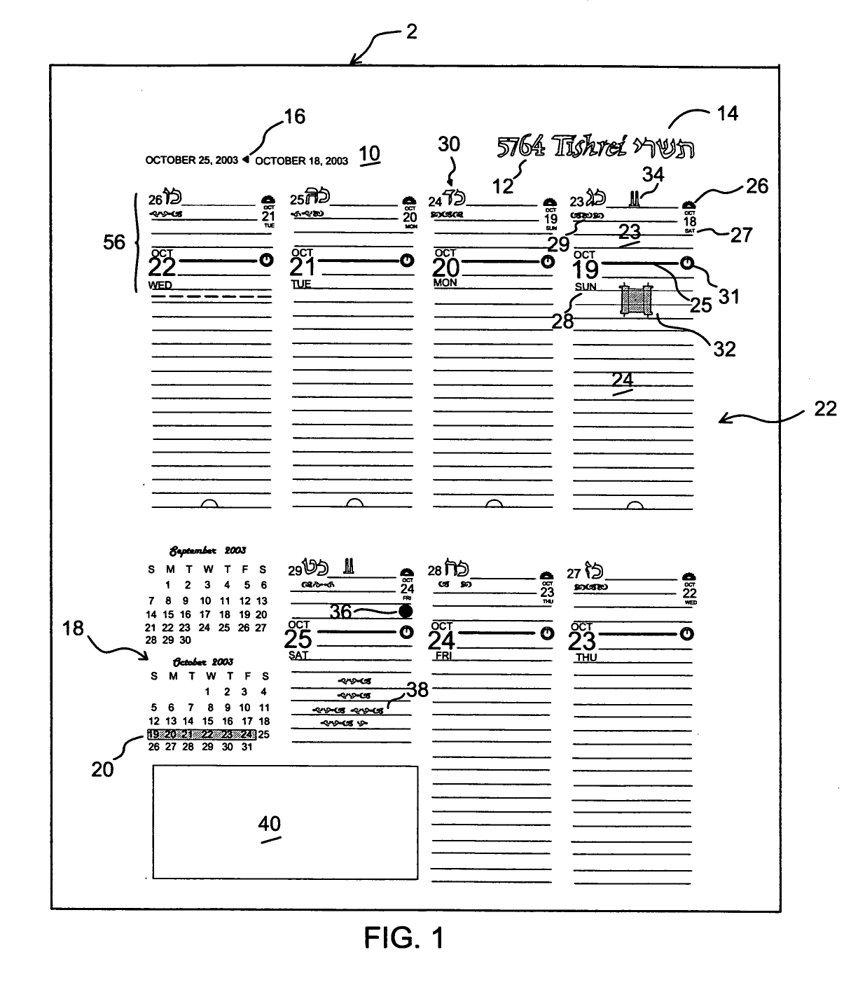

The present invention is a Jewish day planner 2 that integrates the secular/solar day, month, and year within the Jewish/lunar structure. The Jewish day planner 2 includes at least one Jewish calendar week per page, as illustrated in FIG. 1, yet it should be understood that the Jewish calendar illustration can include a daily, monthly, or yearly format. Thus, the indicia on the day planner 2 can show a respective plurality of days, a respective one or more weeks, a respective one or more months, or a respective one or more years. Referring to FIG. 1, the day planner 2 primarily includes a plurality of day planner weekly sheets 10 either in loose form or assembled together via a binder or other means known in the art (not shown). Each weekly sheet 10 includes the Hebrew year 12 at the top of the weekly sheet 10. Adjacent to the Hebrew year 12 is the month 14 in both English and Hebrew. As illustrated in FIG. 1, the representative Hebrew year 12 is 5764 and the month 14 is Tishrei. At the top of the weekly sheet 10, the day range 16 that the weekly sheet 10 covers is indicated. As can be seen by the day range 16 and via inspection of the weekly sheet 10, the day planner 2 is read from right to left. Toward the bottom of the weekly sheet 10, the Gregorian months that include the month Tishrei 18 are illustrated with the Gregorian dates covered by a particular weekly sheet in highlight 20.

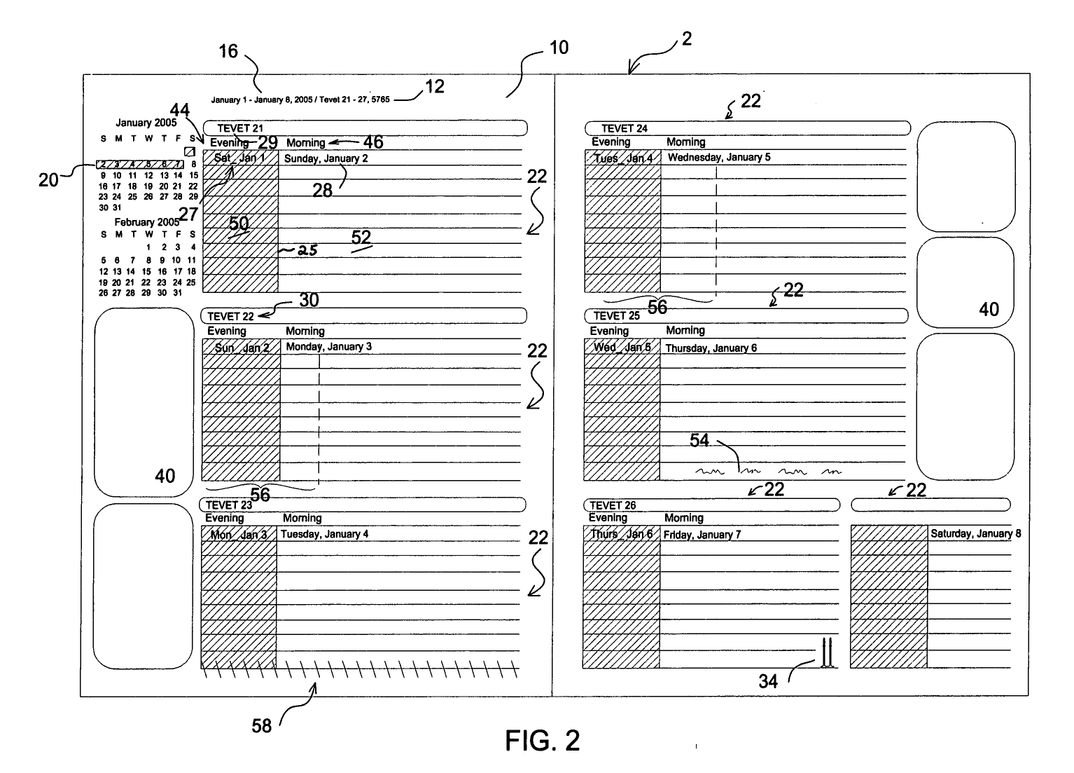

Each weekly sheet 10 is composed of seven (7) day blocks 22. Each day block 22 has an upper lined portion 23 and a bottom lined portion 24 preferably separated by dividing indicia 25, such as a bold line. The upper lined portion 23 may be of a different color or shading than the bottom lined portion 24. Further, as discussed more thoroughly in regard to FIG. 2 below, the upper lined portion 23 may have varied shading or coloring 56 depending on the length of time from sunset to sunset. The upper lined portion 23 and the bottom lined portion 24 typically have a plurality of horizontal lines, however, vertical lines may be used. Further, the upper lined portion 23 and the bottom lined portion 24 may not contain lines. The adjacent positioning of the upper lined portion 23 and the bottom lined portion 24 allow them to coact with one another, as they are preferably positioned atop of one another. At the upper right corner of the upper portion 23 of a day block 22 is a sunset 26 and a first Gregorian date 27. The first Gregorian date 27 (at sunset) is the date that the corresponding Jewish calendar day 29 or lunar calendar day begins and the previous Jewish calendar day ends. The sunset 26 aids in visually representing the lunar day spanning from a first sunset to a second sunset. A Jewish calendar day 29 is shown at the upper left corner of the upper portion 23 of a day block 22. The second Gregorian date 28 is shown at the upper left corner of the bottom portion 24 of a day block 22. For example, the 23^{rd} of Tishrei begins at sunset on Saturday, October 18^{th}. However, the bulk of the 23^{rd} of Tishrei is on Sunday, October 19^{th}. Each day block 22 has a clock 31 adjacent to dividing indicia 25. The clock 31 shows midnight, the time of which the first Gregorian date 27 changes to the second Gregorian date 28 during the same Jewish calendar day 29. Thus, the Gregorian date 28 is shown spanning from midnight to midnight. The clock 31 aids in visually representing the solar day spanning from midnight to midnight.

Each weekly sheet 10 has Jewish holiday indicia 32 on respective celebratory days. Additionally, candle lighting times 34 according to Jewish law may be represented via candle indicia. The phases of the moon 36 are also present on the weekly sheets 10 when applicable. Further, relevant portions of the Torah 38 are designated that correspond with Jewish religious readings. For example, Shabbat Mevarchim is written in Hebrew and English on the bottom portion 24 of the 29^{th} of Tishrei to illustrate the portion of the Torah 38 to be read on the Sabbath. Finally, an artwork or graphic area 40 may be located at the bottom of each weekly sheet 10.

A second embodiment of the present invention is shown in FIG. 2. Each weekly sheet 10 is composed of (7) day blocks 22. In contrast to FIG. 1, the day blocks 22 are arranged vertically in ascending order. Each day block 22 has a left lined portion 50 and a right lined portion 52. The left lined portion 50 and the right lined portion 52 typically have horizontal lines, however, vertical lines may be used. Further, the left lined portion 50 and the right lined portion 52 may not contain lines. The adjacent positioning of the left lined portion 50 and the right lined portion 52 allow them to coact with one another, as they are preferably positioned beside one another. The left lined portion 50 is preferably separated from the right lined portion 52 by dividing indicia 25, such as a bold line. The left lined portion 50 is preferably shaded or of a different color than the right lined portion 52 to indicate the division between a first Gregorian date 27 and a second Gregorian date 28 which make up one complete Jewish calendar day 29 that spans from sunset to sunset or a full lunar day. Further, as shown in phantom, a varied shading or coloring portion 56 is present to visually indicate changes in the time span from sunset to sunrise. Hence, when the time from sunrise to sunset is shorter, the varied shading or coloring portion 56 will be smaller and vice versa for respective days. For example, in winter the time span from sunset to sunrise will be longer than during the summer. The day planner can then indicate this by varying the length of the shading for the days and, likewise the non-shaded portion will be varied. Additionally, a plurality of hatch marks 58 may be provided along the periphery or in the interior of one or more day blocks 22. The hatch marks 58 represent intervals of time, such as minutes or hours. The hatch marks 58 further enable a user to visually appreciate a time during a given day in which a certain event will occur, such as the time of sunrise or sunset for a given day. The first Gregorian date 27 is the day that the Jewish calendar day 29 begins. The Jewish calendar day 29 is shown at the upper left corner above a day block 22. As illustrated in FIG. 2, the 21st of Tevet begins at sunset on Saturday, January 1, indicated as evening 44. However, the bulk of the 21st of Tevet is on Sunday, January 2, indicated as morning 46. The shading of the left lined portion 50 permits a user to readily appreciate the splitting of two Gregorian days over one Lunar day. The second embodiment embraces a majority of the features of the first embodiment, including candle lighting times 34, artwork or graphic areas 40 located at various areas on the day planner weekly sheet 10, and an illustration of the Gregorian dates covered by a particular weekly sheet 10 in highlight 20. Further, the second embodiment may provide historical notes or facts 54 when relevant to a particular day block 22. Also, the second embodiment need not be limited to a day planner 2 having seven day blocks 22 per sheet 10. The day planner 2 can have a day per page or have a complete month or year on a sheet of paper, as examples.

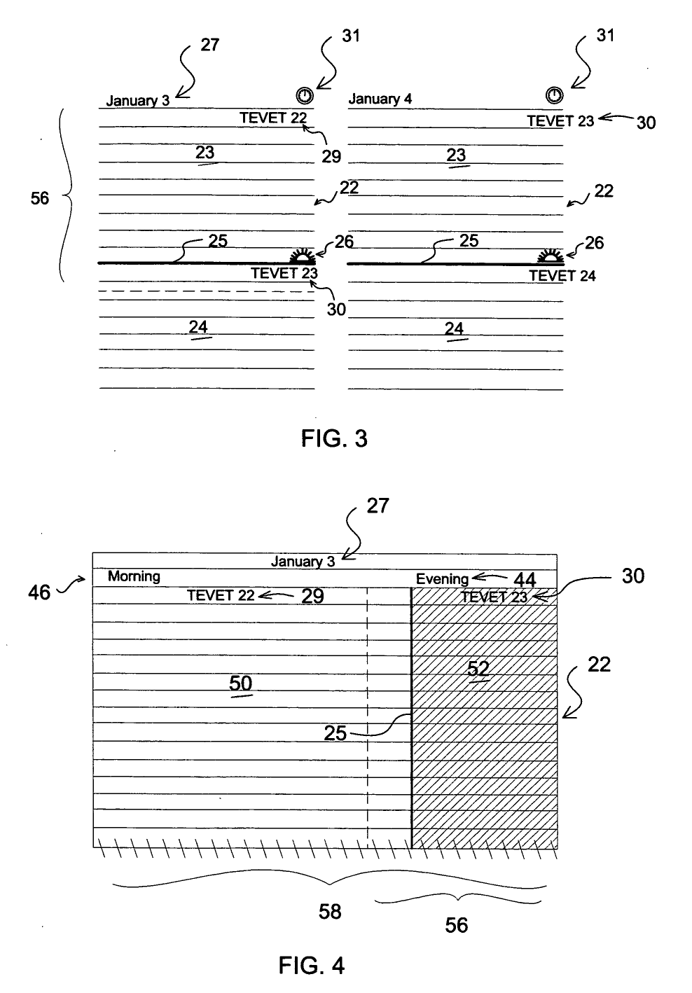

An alternative embodiment of the day planner 2 is generally represented in FIG. 3. FIG. 3 shows two representative day blocks 22 in a reverse arrangement from the day blocks 22 represented in FIG. 1. As illustrated, each day block 22 also has an upper lined portion 23 and a bottom lined portion 24 preferably separated by dividing indicia 25, such as a bold line. The upper lined portion 23 may be of a different color or shading than the bottom lined portion 24. Further, as discussed above in regard to FIGS. 1 and 2, the upper lined portion 23 may have varied shading or coloring 56 depending on the length of time from sunset to sunset. The upper lined portion 23 and the bottom lined portion 24 typically have a plurality of horizontal lines, however, vertical lines may be used. Further, the upper lined portion 23 and the bottom lined portion 24 may not contain lines. The adjacent positioning of the upper lined portion 23 and the bottom lined portion 24 allow them to coact with one another, as they are preferably positioned atop of one another. At the upper left corner of the upper portion 23 of a day block 22 is an entire first Gregorian date 27. A clock 31 striking midnight may be shown to visually represent the beginning of the Gregorian date 27. At the bottom of the upper lined portion 23, a sunset 26 may be represented. The sunset 26, as well as the dividing indicia 25, visually represents the ending of a first Jewish calendar day 29 and the beginning of a second Jewish calendar day 30. The first Jewish calendar day 29 is shown at the upper right corner of the upper lined portion 23 of the day block 22. The second Jewish calendar day 30 is shown at the upper right corner of the bottom lined portion 24 of the day block 22. For example, January 3^{rd} begins at midnight, as the bulk of the 22^{nd} of Tevet remains. At sunset, the 23^{rd} of Tevet begins and the remainder of January 3^{rd} begins to wane. The bulk of the 23^{rd} of Tevet occurs over the beginning of January 4^{th}. Thus, each day block 22 represents an entire Gregorian date 27 and parts of first and second Jewish calendar days 29 and 30. As will be readily appreciated, the day blocks 22 of the present embodiment may be utilized in a day planner 2 in any manner as described herein. Thus, a day planner 2 using the day blocks 22 of this embodiment may also include candle lighting times 34, artwork or graphic areas 40 located at various areas on the day planner weekly sheet 10, and an illustration of the Gregorian dates covered by a particular weekly sheet 10 in highlight 20. Further, the day planner 2 may provide historical notes or facts 54 when relevant to a particular day block 22. Also, the day planner 2 need not be limited to a day planner 2 having seven day blocks 22 per sheet 10. The day planner 2 can have a day per page or have a complete month or year on a sheet of paper, as examples.

A further alternative embodiment of the day planner 2 is generally represented in FIG. 4. FIG. 4 shows one day block 22 in a reverse arrangement from the day blocks illustrated in FIG. 2. Each day block 22 has a left lined portion 50 and a right lined portion 52. The left lined portion 50 and the right lined portion 52 typically have horizontal lines, however, vertical lines may be used. Further, the left lined portion 50 and the right lined portion 52 may not contain lines. The adjacent positioning of the left lined portion 50 and the right lined portion 52 allow them to coact with one another, as they are preferably positioned beside one another. The left lined portion 50 is preferably separated from the right lined portion 52 by dividing indicia 25, such as a bold line. The right lined portion 52 is preferably shaded or of a different color than the left lined portion 50 to indicate the division between a first Jewish calendar day 29 and a second Jewish calendar day 30 which make up one complete Gregorian date 27 that spans from sunset to sunset or a full lunar day. Further, as shown in phantom, a varied shading or coloring portion 56 is present to visually indicate changes in the time span from sunset to sunset. Hence, when the time from sunset to sunset is shorter, the varied shading or coloring portion 56 will be smaller and vice versa. Additionally, a plurality of hatch marks 58 may be provided along the periphery or in the interior of one or more day blocks 22. The hatch marks 58 represent intervals of time, such as minutes or hours. The hatch marks 58 further enable a user to visually appreciate a time during a given day in which a certain event will occur, such as the time of sunrise or sunset for a given day. The Gregorian -date 27 encompasses two partial Jewish calendar days 29 and 30. The Gregorian date 27 is preferably shown at the top of the day block 22. The first Jewish calendar day 29 is preferably shown at the top of the left lined portion 50. The second Jewish calendar day 30 is preferably shown at the top of the right lined portion 52. For example, January 3^{rd} begins at midnight, as the bulk of the 22^{nd} of Tevet remains. At sunset, the 23^{rd} of Tevet begins and the remainder of January 3^{rd} begins to wane. The bulk of the 23^{rd} of Tevet occurs over the beginning of January 4^{th}. Thus each day block 22 represents an entire Gregorian date 27 and parts of first and second Jewish calendar days 29 and 30. As will be readily appreciated, the day blocks 22 of the present embodiment may be utilized in a day planner 2 in any manner as described herein. As will be readily appreciated, the day block 22 of the present embodiment may be utilized in a day planner 2 in any manner as described herein. Thus, a day planner 2 using the day block 22 of this embodiment may also include candle lighting times 34, artwork or graphic areas 40 located at various areas on the day planner weekly sheet 10, and an illustration of the Gregorian dates covered by a particular weekly sheet 10 in highlight 20. Further, the day planner 2 may provide historical notes or facts 54 when relevant to a particular day block 22. Also, the day planner 2 need not be limited to a day planner 2 having seven day blocks 22 per sheet 10. The day planner 2 can have a day per page or have a complete month or year on a sheet of paper, as examples.

It will be readily appreciated that the day planner 2 may be used with or printed on a variety of media. For instance, the day planner 2 may be produced on print paper or it may be developed into a software program for use with computer or electronic systems, such as common desktop or laptop computers, personal digital assistants, cellular phones, and other digital media now known or heretofore developed.

An entire Jewish calendar year can be constructed by including the appropriate number of Jewish calendar weeks and months. It is to be understood that Jewish calendar weeks apart from the Jewish calendar week disclosed in FIGS. 1 and 2 and projected and disclosed in FIGS. 3 and 4, can be created and appreciated by applying the same basic principles as have already been outlined. Additionally, other types of indicia, such as different shadings, configurations, or geometric shapes having a perimeter, can be provided so that the user can identify a corresponding Jewish calendar day and a Gregorian calendar day quickly and efficiently. Furthermore, the present invention can also be used to correspond other types of calendars with one another. Thus, visual indicia can also be used to correspond non-lunar based calendars with solar-based calendars. It is noteworthy to mention that the lunar year contains 354 days, eleven days less than the solar year. Since the Torah requires that holidays occur within particular seasons, it becomes necessary to add a thirteenth month (i.e., Adar I) seven times in nineteen years. This adjustment guarantees that Passover is celebrated in the spring and Sukkot in the fall.

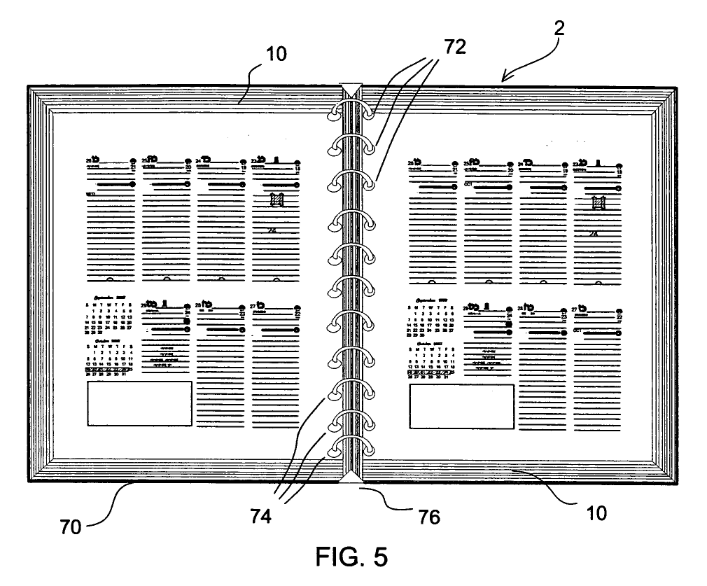

FIG. 5 illustrates a ring binder day planner 2 according to the present invention. As shown, the day planner 2 includes a plurality of day planner weekly sheets 10 on print paper assembled together via a plurality of rings 72 attached to a ring binder 70. Each weekly sheet 10 has a plurality of rings 72 to securably catch a corresponding plurality of holes 74. Further, the ring binder 70 has a releasable locking mechanism 76 well-appreciated in the art to allow for the addition or subtraction of weekly sheets 10. As will be understood by one of ordinary skill in the art, the weekly sheets 10 can also be in daily, monthly or yearly format. Further, instead of rings 72, the day planner 2 may be assembled in a bound book format, by string, by ribbon, or by any other means now known or heretofore developed in the art.

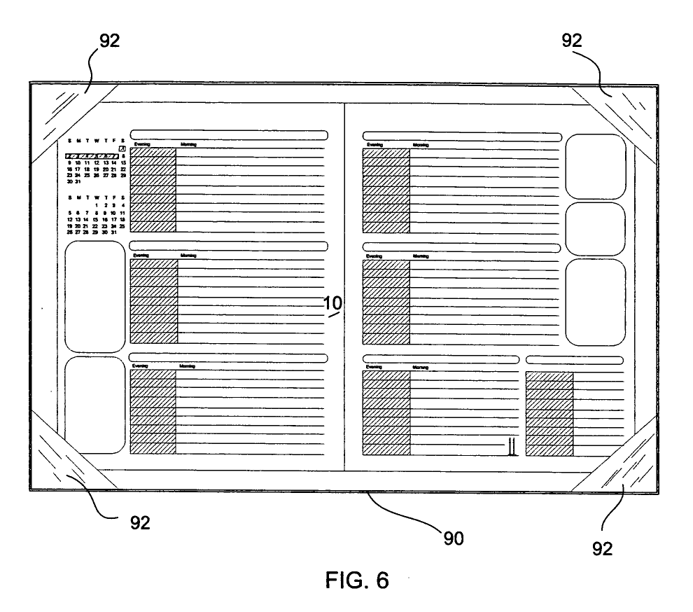

FIG. 6 illustrates a desktop day planner 2 according to the present invention. As shown, the day planner 2 includes a plurality of day planner weekly sheets 10 encased in a rigid to semi-rigid winged holder 90. The winged holder 90 has a plurality of wings 92 in which to encase a plurality of day planner weekly sheets 10 either in loose form or lightly bound together for easy removal. The winged holder 90 and wings 92 may be made of cardboard, plastic, leather, synthetic leather, natural or synthetic woven materials, or a combination thereof. Further, as will be appreciated by one of ordinary skill in the art, the weekly sheets 10 can also be in daily, monthly, or yearly format.

The present invention has been described with reference to the preferred embodiments. Obvious modifications, combinations, and alterations will occur to others upon reading the preceding detailed description. It is intended that the invention be construed as including all such modifications, combinations, and alterations insofar as they come within the scope of the appended claims or the equivalents thereof.

The invention claimed is:

1. A day planner, comprising a medium upon which a plurality of indicia is applied, wherein each of the indicia is visually indicative of a first time parameter and a second time parameter; and wherein the first time parameter and the second time parameter are not the same.

2. A day planner, comprising a medium upon which a plurality of indicia is applied, wherein each of the indicia:
is visually indicative of a complete lunar day and a partial solar day; and
comprises a first portion and a second portion, the first portion identifying a beginning of the complete lunar day and an ending of a first solar day, the second portion identifying a beginning of a second solar day and an ending of the complete lunar day.

3. A day planner, comprising a medium upon which a plurality of indicia is applied, wherein each of the indicia:
is visually indicative of a complete solar day and a partial lunar day; and
comprises a first portion and a second portion, the first portion identifying a beginning of the complete solar day and an ending of a first lunar day, the second portion identifying a beginning of a second lunar day and an ending of the complete solar day.

4. The day planner of claim 2, wherein each of the indicia coacts with adjacent indicia.

5. The day planner of claim 2, wherein the indicia represents the lunar day from a first sunset to a second sunset.

6. The day planner of claim 2, wherein the indicia represents the solar day from a first midnight to a second midnight.

7. The day planner of claim 2, wherein each indicia form a plurality of indicia identifying:
a respective plurality of days;
a respective one or more weeks;
a respective one or more months; or
a respective one or more years.

8. The day planner of claim 2, wherein the first portion comprises a plurality of horizontal lines and the second portion comprises a plurality of horizontal lines.

9. The day planner of claim 2, wherein the first portion is adjacent to the second portion.

10. The day planner of claim 2, wherein the first portion is positioned above the second portion.

11. The day planner of claim 2, wherein the first portion is positioned beside the second portion.

12. The day planner of claim 2, wherein a bold line separates the first portion and the second portion.

13. The day planner of claim 2, wherein the first portion is a different color than the second portion.

14. The day planner of claim 13, wherein an amount of different color varies according to a length of time from the first sunset to the second sunset.

15. The day planner of claim 2, wherein a plurality of hatch marks are provided on at least one of the first portion and the second portion to represent intervals of time.

16. The day planner of claim 2, wherein time indicia is located on at least one of the first portion and the second portion.

17. The day planner of claim 5, further comprising a plurality of sunset indicia to visually indicate the lunar day spanning from the first sunset to the second sunset.

18. The day planner of claim 6, further comprising a plurality of clock indicia to visually indicate the solar day spanning from the first midnight to the second midnight.

19. The day planner of claim 2, further comprising at least one of a candle indicia to visually indicate candle lighting times according to Jewish custom.

20. The day planner of claim 2, wherein the medium is at least one of a print paper or digital media.
